(19) United States
(12) Patent Application Publication
(10) Pub. No.: US 2012/0240082 A1
(43) Pub. Date: Sep. 20, 2012

(54) OPERATION METHOD OF INTERACTIVE SERVICE SYSTEM AND MENU THEREOF

(75) Inventor: Chin-Lung Chen, Taichung City (TW)

(73) Assignee: CHUNGHWA WIDEBAND BEST NETWORK, Taichung City (TW)

(21) Appl. No.: 13/354,303

(22) Filed: Jan. 19, 2012

(30) Foreign Application Priority Data
Mar. 18, 2011 (TW) 100204946

(51) Int. Cl. G06F 3/048

(52) U.S. Cl. 715/823; 715/810

(57) ABSTRACT

An operation method of an interactive service system is disclosed. The method includes the following steps: (1) providing a first menu, wherein the first menu has a plurality of first options arranged in a first array marked by a label selected from the group consisting of a numeral, icon, word and color; (2) selecting one of the first options in the first menu; and (3) providing an interactive service or a next layer menu according to the selected first option.

### BACKGROUND OF THE INVENTION

1. Field of the Invention

The present disclosure relates to an operation method and a menu of an interactive service system, and more particularly to an operation method and a menu of an interactive service system which enable a user to operate the system more intuitively.

2. Description of Related Art

Due to favorable factors such as complete construction of network equipments and voluminously increased network bandwidth, multimedia on-demand (MOD) services gradually enter into people's daily life. Via MOD services, users can watch video programs, do entertainment activities, or deal with financial affairs at any time period. For example, watching TV programs, movies, dramas, or cartoons, browsing news, searching information, playing sport games, singing karaoke, education courses, even financial analyses, shopping, transferring moneys or managing assets, all of them can be accomplished through interactive on-demand systems.

However, ordinary interactive on-demand systems have complex operation interfaces, users often need to select items back and forth between previous layer menus and next layer menus. Especially, speaking of an LCD TV having a large screen, in order to allow a user to see all function options at a time, the first layer menu even contains all options. Therefore, the user has to look at each option carefully and move the cursor step by step to pick the desired service option. When the user is handling other things such that the user is unable to see the TV screen or distracted carelessly, the user often selects a wrong option. In other words, the conventional interactive on-demand system in prior art can't provide an operation method and a menus through which the user can select service options more conveniently and intuitively.

### SUMMARY OF THE INVENTION

In view of disadvantages in prior art, the objective of the present disclosure is to provide an operation method of an interactive service system through which a user can operate the interactive service system conveniently.

Another objective of the present disclosure is to provide a menu of an interactive service system for a user to select one option of the menu more conveniently and intuitively.

In order to achieve the above or other objectives, the present disclosure discloses an operation method of an interactive service system. The method includes the following steps. First, provide a first menu, wherein the first menu has a plurality of first options arranged in a first array marked by a label selected from the group consisting of a numeral, icon, word, and color. Second, select one of the first options in the first menu. Then, provide an interactive service or a next layer menu according to the selected first option.

According to the operation method described in one embodiment of the present disclosure, the next layer menu is a second menu. The second menu has a plurality of second options arranged in a second array marked by a label selected from the group consisting of a numeral, icon, word, and color, and so on for each subsequent layer menu.

According to the operation method described in one embodiment of the present disclosure, the first options are marked by different numerals, icons, words, colors or combinations thereof. The interactive service may be, for example, playing videos, puzzle games, life information inquiring, money transferring and financial transaction, photo album browsing, karaoke television, television shopping, or voice communication.

According to the operation method described in one embodiment of the present disclosure, the step of selecting one of the first options in the first menu is performed by using a remote device. The remote device may comprise a remote controller, a touch screen or a keypad. Wherein, the remote device has key buttons marked by different numerals, icons, words, colors or combinations thereof.

In one embodiment of the present disclosure, the options are marked by different numerals, icons, words, colors or combinations thereof. Therefore, in the operation method of the interactive service system according to the present disclosure, the step of selecting one of the first options in the first menu is performed by pressing one of the key buttons corresponding to the marked numerals, icons, words, colors or combinations thereof in the first menu.

According to the operation method described in one embodiment of the present disclosure, the step of selecting one of the first options in the first menu is performed by moving a cursor to a position of a desired option for selecting.

According to the operation method described in one embodiment of the present disclosure, each row or column of the first array may be highlighted by different background colors, so that a user may easily identify each row or column.

According to one specific embodiment of the present disclosure, the first options are arranged in the first array, wherein the first array is a pound sign array which contains nine options, and the numbers of rows and columns of the first array are both three. The options are respectively marked by different numerals, icons, words, colors or combinations thereof. That is to say, the first options are arranged in the pound sign array or an array of a 3 by 3 grid.

In view of the above, within the menu of the interactive service system disclosed in the present disclosure, each option is arranged in the “pound sign” array (a tic-tac-toe board) such that a user may select a desired service option via corresponding options in the menu. Therefore, by using the operation method of the interactive service system disclosed in the present disclosure, the operation of the system will become more easily and faster.

In order to the make aforementioned and other objectives, features and advantages of the present disclosure comprehensible, preferred embodiments accompanied with figures are described in detail below.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic structural diagram of the interactive service system according to one preferred embodiment of the present disclosure.

FIG. 2 is a schematic diagram of the menu of the interactive service system according to one preferred embodiment of the present disclosure.

FIG. 3 is a schematic diagram of another menu of the interactive service system according to one preferred embodiment of the present disclosure.

FIG. 4 is a flowchart illustrating the operation method of the interactive service system according to one preferred embodiment of the present disclosure.

FIG. 5 is a schematic diagram of the menu of the interactive service system according to another preferred embodiment of the present disclosure.

### DESCRIPTION OF THE EMBODIMENTS

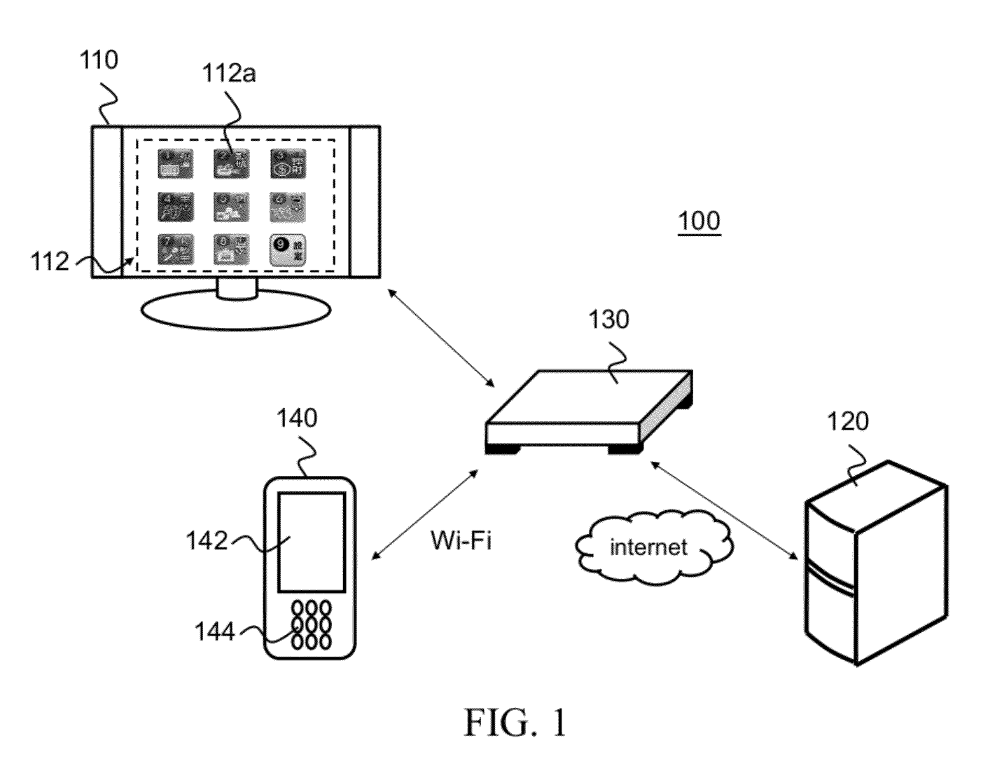

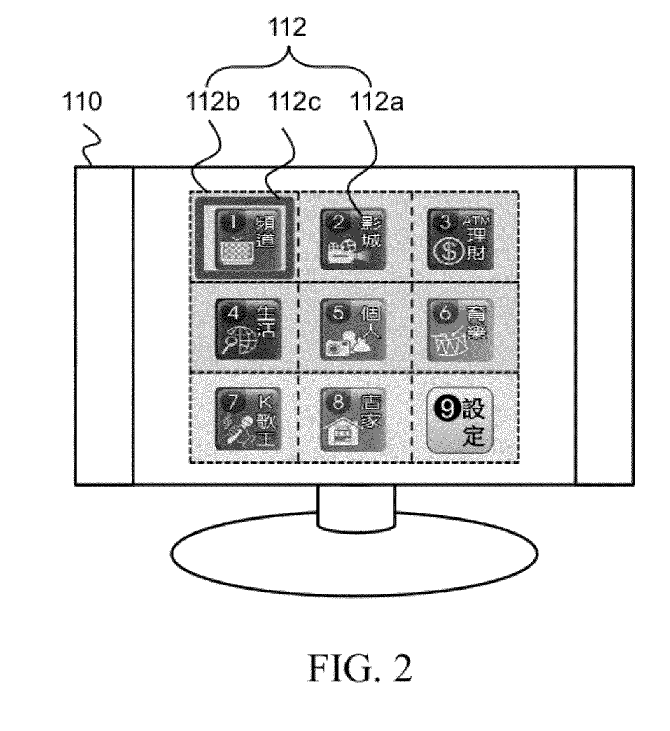

FIG. 1 is a schematic structural diagram of the interactive service system according to one preferred embodiment of the present disclosure. FIG. 2 is a schematic diagram of the menu of the interactive service system according to one preferred embodiment of the present disclosure.

Please refer to FIG. 1 first. The interactive service system 100 of the present disclosure includes a display device 110, a server 120, an intermediate module 130 and a remote device 140. The interactive service system 100 is, for example, a multimedia on-demand system, a video on-demand system, or other device assemblies which can perform interactive services. The intermediate module 130 is connected among the display device 110 and the server 120. The display device 110 may be, for example, an LCD TV, a computer monitor, or a projector screen. The intermediate module 130 may be, for example, a set-top box, a universal serial bus (USB) device, a mobile communication device, or other similar devices. The server 120 is, for example, a multimedia server, a file server, an application program server, or a relational database server.

As shown in FIG. 2, the display device 110 displays a first menu 112, and the first menu 112 has a plurality of first options 112a. In the present embodiment, the first options 112a are marked by numerals, icons, words, colors or combinations thereof. After a user selects one first option 112a, the server 120 will respond to the selected first option 112a and transmit back data of the corresponding interactive service. The intermediate module 130 then transforms the data of the corresponding interactive service into signals of video frames. Furthermore, the signals are transmitted to the display device 110, and image frames of the corresponding interactive service or a next layer menu will be displayed on the screen of the display device 110.

The remote device 140 transmits commands into the intermediate module 130 through transmission mediums such as infrared rays (IR), radio frequency (RF), wireless fidelity (Wi-Fi), or other suitable transmission mediums. The remote device 140 has a touch screen 142 and a keypad 144 for the user to select the options 112a. Also, the user may input necessary information of the interactive service into the server 120 through the touch screen 142 or the keypad 144.

In order to make the interactive service system 100 work, the intermediate module 130 has to connect to the server 120. The connection may be achieved by cable television systems or internet. While the connection is built by cable television systems, the intermediate module 130 may connect to the server 120 through coaxial cable lines of the cable television systems. While the connection is built by internet, the intermediate module 130 may connect to the server 120 through optical fiber networks, telephone data lines, wireless fidelity (Wi-Fi), 3.5G mobile communication, worldwide interoperability for microwave access (WiMAX), or long term evolution (LTE) technologies.

Next, please refer to FIG. 2 which illustrates a first menu 112 displayed on the display device 110 (for example, an LCD TV) of FIG. 1. There are multiple first options 112a contained in the first menu 112. Each first option 112a represents an interactive service or a next layer menu. The interactive service is, for example, playing videos, puzzle games, life information inquiring, money transferring and financial transaction, photo album browsing, karaoke television, television shopping, or voice communication. The user may select one option 112a in the first menu 112 through the interactive service system 100 of the present disclosure, so as to perform an interactive service or enter into a next layer menu. After the user selects one option 112a, the display device 110 then displays video frames of the corresponding interactive service or the next layer menu.

The first options 112a are arranged in a first array 112b. As shown in FIG. 2, the numbers of rows and columns of the first array 112b are both three, and there are nine options arranged within the first array in the form of a pound sign. The options are respectively remarked by combinations of different numerals, icons, words and colors. That means the first options are exactly arranged in the pound sign array (a tic-tac-toe board) or the 3 by 3 grid. In order to enable the user to select any one of the first options 112a, there is still a cursor 112c contained in the menu. In the present disclosure, the cursor 112c can be moved across the options. Besides, movement of the cursor 112c is controlled through the remote device 140.

Furthermore, in the present embodiment, each row of the first array 112b has a different background color. Of course, in other embodiments, the interactive service system may be configured such that each column of the first array 112b has a different color as well.

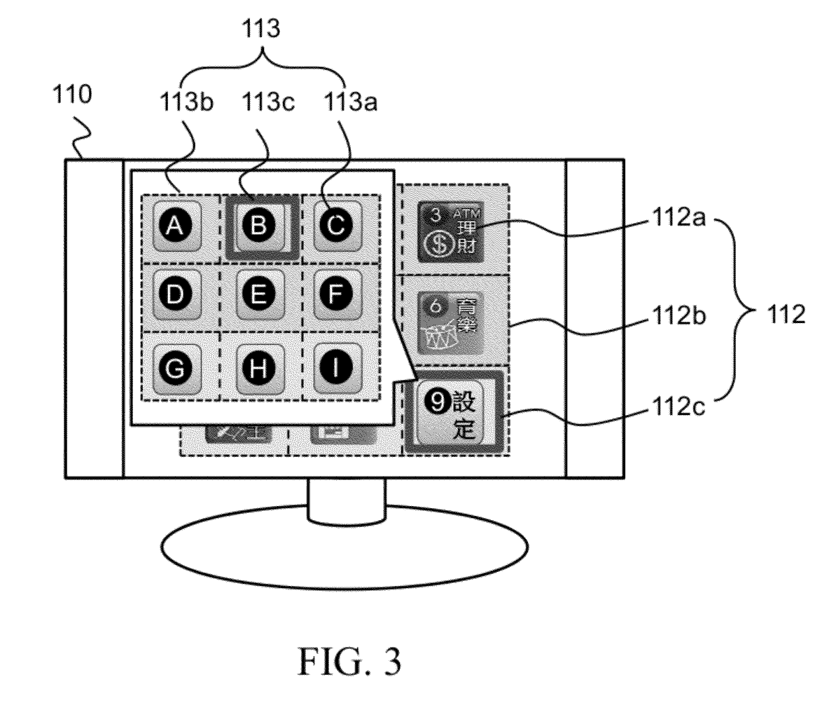

FIG. 3 is a schematic diagram of another menu of the interactive service system according to one preferred embodiment of the present disclosure. When the selected first option 112a represents entering into the next layer menu, the display device 110 displays a second menu 113 correspondingly. Similar to the first menu 112, the second menu 113 contains multiple second options 113a which are arranged in a second array 113b. The cursor 113c is used to select the second options 113a. In the present disclosure, the second options 113a are respectively marked by combinations of different numerals, icons, words and colors.

It should be noted, generally, a pound sign array usually appears in a tic-tac-toe game, and the 3 by 3 grid usually appears on a dial of a button type telephone. Therefore, most people can very easily remember contents arranged within the pound sign array or the 3 by 3 grid. For example, it is very easy to remember which position in the pound sign array is labelled with a circle glyph or a cross glyph, or to remember positions of numerals 1 to 9 on the dial of the button type telephone. The present disclosure utilizes the pound sign array or the 3 by 3 grid to the menu 112 of the interactive service system 100, which enables the user to easily remember that which option 112a at a position of the first array 112b corresponds to a specific service. In other words, the user can select the desired service by intuition.

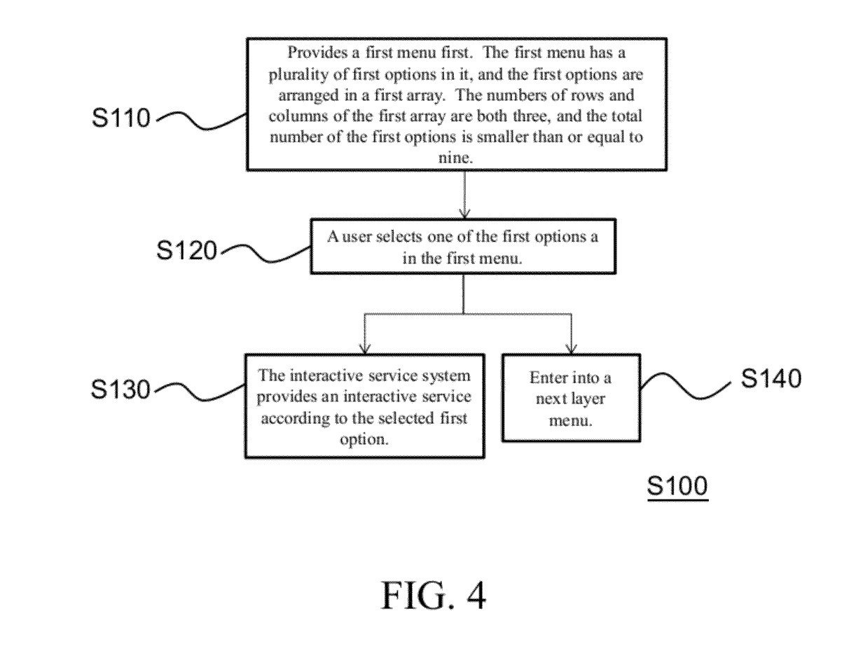

According to above description, the present disclosure actually provides an operation method of an interactive service system. FIG. 4 is a flowchart illustrating the operation method of the interactive service system according to one preferred embodiment of the present disclosure. Please refer to FIG. 4, at step S110 within the operation method S100 of the interactive service system described in one preferred embodiment of the present disclosure, the interactive service system 100 provides a first menu 112 in the first instance. The first menu 112 has a plurality of first options 112a in it, and the first options are arranged in a first array 112b. The numbers of rows and columns of the first array are both three, and there are nine options arranged within the array in the form of a pound sign, in which the options are respectively marked by combinations of different numerals, icons, words and colors. That is, the first options 112a exactly fill in the pound sign array or the 3 by 3 grid (step S110). Then, the user selects one of the first options 112a in the first menu 112 (step 120). Thereafter, the interactive service system 100 will provide an interactive service (step 130) or enter into a next layer menu (step 140) according to the selected first option 112a.

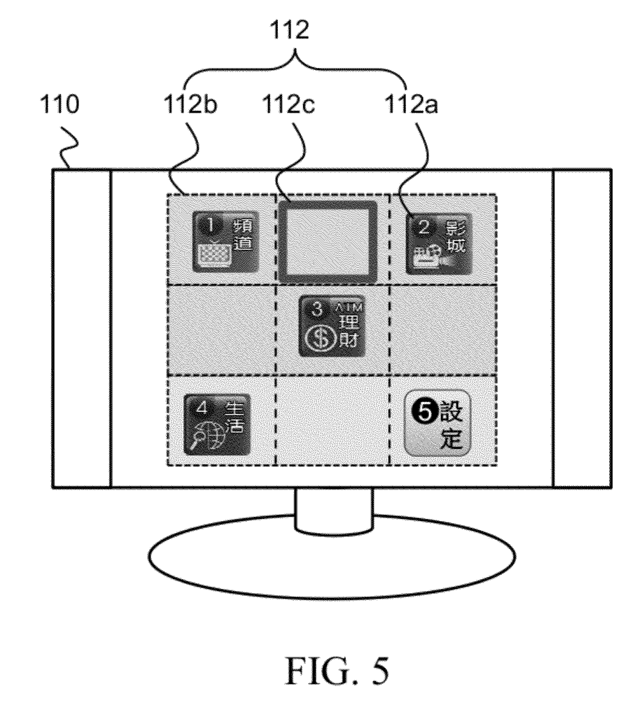

FIG. 5 is a schematic diagram of the menu of the interactive service system according to another preferred embodiment of the present disclosure.

It should be emphasized that although the first options 112a or the second options 113a in the present disclosure are both arranged in arrays, each containing nine options ranked in in the form of a pound sign and respectively marked by combinations of different numerals, icons, words and colors, the first options 112a or the second options 113a may also be set up in the same way in other embodiments. As shown in FIG. 5, the user may configure the total numbers of the first options and the second options according to the user's preference. The user may also configure position arrangement of the first options and the second options in the first array and the second array to achieve a menu state which is considered the most convenient.

In view of the above, the interactive service system of the present disclosure at least has the following advantages:

(1) In the menus of the interactive service system, each option is arranged in an array and marked by a different numeral, icon, word, color or combination thereof, so a user may select a desired service option by intuition. Hence, by using the operation method of the interactive service system disclosed in the present disclosure, operation of the system will become more convenient and faster.

(2) In the menus of the interactive service system, the numbers and positions of the options may be flexibly adjusted and arranged in an array, and each of the options may be marked by different numerals, icons, words, colors or combinations thereof. Therefore, by using the operation method of the interactive service system disclosed in the present disclosure, a user may set the menus to a state which is considered the most convenient.

Although the present disclosure has been already disclosed by the above embodiments, these embodiments are not used to limit the present disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An operation method of an interactive service system, comprising:
providing a first menu, wherein the first menu has a plurality of first options arranged in a first array marked by a label selected from the group consisting of a numeral, icon, word and color;
selecting one of the first options in the first menu; and
providing an interactive service or a next layer menu according to the selected first option.

2. The operation method as claimed in claim 1, wherein the first options are marked by different numerals.

3. The operation method as claimed in claim 1, wherein the first options are marked by different icons.

4. The operation method as claimed in claim 1, wherein the first options are marked by different words.

5. The operation method as claimed in claim 1, wherein the first options are marked by different colors.

6. The operation method as claimed in claim 1, wherein the first options are marked by combinations of different numerals, icons, words and colors.

7. The operation method as claimed in any one of claim 1 to claim 6, wherein the first options are arranged in a first array, the first array is a pound sign array or a 3 by 3 grid, the numbers of rows and columns of the first array are both three, and the first array contains nine options.

8. The operation method as claimed in claim 1, wherein the next layer menu is a second menu, the second menu has a plurality of second options arranged in a second array marked by a label selected from the group consisting of a numeral, icon, word and color, and so on for each subsequent layer menu.

9. The operation method as claimed in claim 1, wherein the interactive service comprises playing videos, puzzle games, life information inquiring, money transferring and financial transaction, photo album browsing, karaoke television, television shopping, or voice communication.

10. The operation method as claimed in claim 1, wherein the step of selecting one of the first options in the first menu is performed by using a remote device.

11. The operation method as claimed in claim 10, wherein the remote device comprises a remote controller, a touch screen or a keypad.

12. The operation method as claimed in claim 11, wherein the remote device has key buttons marked by different numerals, icons, words, colors or combinations thereof.

13. The operation method as claimed in claim 12, wherein the step of selecting one of the first options in the first menu is performed by pressing one of the key buttons corresponding to the marked numerals, icons, words, colors or combinations thereof in the first menu.

14. The operation method as claimed in claim 1, wherein the step of selecting one of the first options in the first menu is performed by moving a cursor to a position of a desired option for selecting.

15. The operation method as claimed in claim 1, wherein each row or column of the first array has a different background color.

16. A menu of an interactive service system, wherein the menu has a plurality of options arranged in an array marked by a label selected from the group consisting of a numeral, icon, word and color.

17. The operation method as claimed in claim 16, wherein the options are marked by different numerals, icons, words, colors or combinations thereof.

18. The operation method as claimed in claim 16, wherein each row or column of the array has a different background color.
